(19) United States
(12) Patent Application Publication
(10) Pub. No.: US 2002/0111857 A1
(43) Pub. Date: Aug. 15, 2002

(54) Digitally marked objects as monetary tokens

(76) Inventors: William E. Harris, Tulsa, OK (US); Mark A. Regouby, Tulsa, OK (US)

Correspondence Address: DIGIMARC CORPORATION, 19801 SW 72ND AVENUE, SUITE 100, TUALATIN, OR, 97062, US

(21) Appl. No.: 09/780,112

(22) Filed: Feb. 9, 2001

(51) Int. Cl. G06F 17/60

(52) U.S. Cl. 705/14

(57) ABSTRACT

The present invention relates to using encoded data as a monetary equivalent or access token. In one embodiment, the encoded data activates an appliance or facilitates a transaction. The encoded data may include monetary information itself, or may be used to index additional information.

### RELATED APPLICATION DATA

The subject matter of the present application is related to that disclosed in copending U.S. application Ser. Nos. 09/343,104, filed Jun. 29, 1999; 09/571,422, filed May 15, 2000; and 09/697,009, filed Oct. 25, 2000. Each of these patent applications is hereby incorporated by reference.

### FIELD OF THE INVENTION

The present invention relates to using digitally marked objects as monetary units or access tokens.

### BACKGROUND AND SUMMARY OF THE INVENTION

As disclosed in the above-cited applications, physical objects can be encoded with digital data. When sensed by a compliant device, the digital data can be used to direct a web browser to an internet web page corresponding to the object. The digital data can also be used to direct or to enable an appliance. The term appliance is used broadly herein to include many apparatus and devices, such as computers, jukeboxes, cash registers, point-of-sale terminals, vending machines, dispensing machines, gates, transportation systems, pay-for-view devices, vehicles, rides, games, pay phones, gaming machines, mechanical devices, and electrical devices, to name just a few.

One form of encoding is accomplished with digital watermarking. Digital watermarking systems typically have two primary components: an encoder that embeds the watermark in a host media signal, and a decoder (or reader) that detects and reads the embedded watermark from a signal suspected of containing a watermark (a suspect signal). The encoder embeds a watermark by altering the host media signal. The decoding component analyzes a suspect signal to detect whether a watermark is present. In applications where the watermark encodes information, the decoder extracts this information from the detected watermark.

Artisans in the field know a great variety of particular watermarking techniques. The reader is presumed to be familiar with the literature in this field. Particular techniques for embedding and detecting imperceptible watermarks in media signals are detailed in the assignee's co-pending application Ser. No. 09/503,881, filed Feb. 14, 2000, and U.S. Pat. No. 5,862,260, each of which are hereby incorporated by reference. Of course, there are other techniques known in the encoding and digital watermarking arts, and such techniques may be employed in the present invention.

One such technique marks objects in a generally human-imperceptible manner using digital watermark technology. For example, a photograph in a magazine advertisement can be subtly changed, in local luminance detail, to encode a 32-bit number (an object identifier). A reading device (e.g., web cam, scanner, etc.) can sense image data corresponding to the photograph or the like. An associated computing device decodes the 32-bit object identifier from the sensed image data. The device can then transmit this identifier to a database. The database uses the identifier to access a corresponding database record. In the record is information relating to the object. The database transmits this information back to the device. In one embodiment, the database is remotely located, and the information includes a URL address. In this case, the device, in turn, launches a web browser (or if already launched, then directs the running web browser) to the specified URL. The web page at that URL is then displayed to the user who initially presented the object to the web cam. In another embodiment, the database is locally maintained and includes information to direct the device.

In accordance with one aspect of the present invention, an object is encoded with digital data. The digital data preferably includes data relating to a monetary unit, credit value, or access token. A reader terminal (e.g., in a restaurant, train terminal, etc.) senses the data and responds in a manner specified by information in an associated database record. Instead of directing a web browser to an associated web page, the information returned by the database can be used, e.g., as a monetary equivalent or token. The monetary tokens can be used to purchase goods, services, or to activate an appliance (e.g., video game, jukebox, children's rides, carnival-like games, vending machines, etc.).

The encoded articles can be produced in large volume—all encoded with the same digital data. The response to this fixed data can be changed daily, weekly, etc., by updating data in the database accordingly. Thus, an inventory of objects produced months ago can be used in conjunction with varying values or promotions at a store or transportation center. Alternatively, the objects can be separately encoded with unique data. This unique data can then be used to manage individual access and/or to restrict use (e.g., a one (1) time use, five-uses, etc.).

A jukebox is provided according to a second aspect of the present invention. The jukebox includes a repository comprising audio or video files, a user interface through which an audio or video file is selected, an output device, and a watermark reader. The watermark reader enables the jukebox to perform the selected audio or video file via the output device. The watermark reader enables the jukebox based on a digital watermark comprising plural-bit data.

A method of activating an appliance is provided according to still another aspect of the present invention. The appliance includes a watermark detector. The method includes the steps of: i) presenting a digitally watermarked object to the detector; ii) in the detector, detecting and decoding the watermark; and iii) activating the appliance in accordance with the watermark.

In another aspect, a physical object is used as a monetary equivalent. The physical object includes plural bit data encoded in the form of a digital watermark. The plural bit data is used to link to additional data, the additional data comprising monetary information.

A method of doing business is another aspect of the present invention. The method includes the steps of: i) reading a digitally watermarked object, the watermark comprising at least an identifier; ii) accessing additional information via the identifier, the additional information comprising monetary data; and iii) using the additional information to facilitate a transaction.

The foregoing and other features and advantages of the present invention will be more readily apparent from the following detailed description, which proceeds with reference to the accompanying drawings.

### BRIEF DESCRIPTION OF THE DRAWINGS

FIG. 1 illustrates a watermark decoder according to an illustrative embodiment of the present invention.

FIG. 2 illustrates an appliance including the watermark decoder of FIG. 1.

### DETAILED DESCRIPTION

An object is encoded with a digital object identifier (e.g., plural-bit data). The identifier is preferably recorded in a database and information is linked to the identifier. The linked information may include information corresponding to a monetary unit, credit amount, and/or access level. The object is presented to a compliant device (e.g., a device capable of reading and/or decoding the encoded object identifier), which reads the object and decodes the identifier. Preferably, the database is queried to determine the linked information. The information is then used to purchase a good or service, activate a device, permit access, etc.

As an alternative arrangement, the article is encoded with additional information. The additional information may be included as part of the identifier or may be included as a payload. The additional information preferably includes plural-bit data corresponding to monetary units, credit amounts, or access levels. This additional information is decoded and used to purchase a good, service, activate a device, permit access, etc.

In yet another arrangement, the identifier includes the access token. The access token (e.g., identifier) is recorded each time it is used. These records can then be used to facilitate payment for access or purchases via the access token.

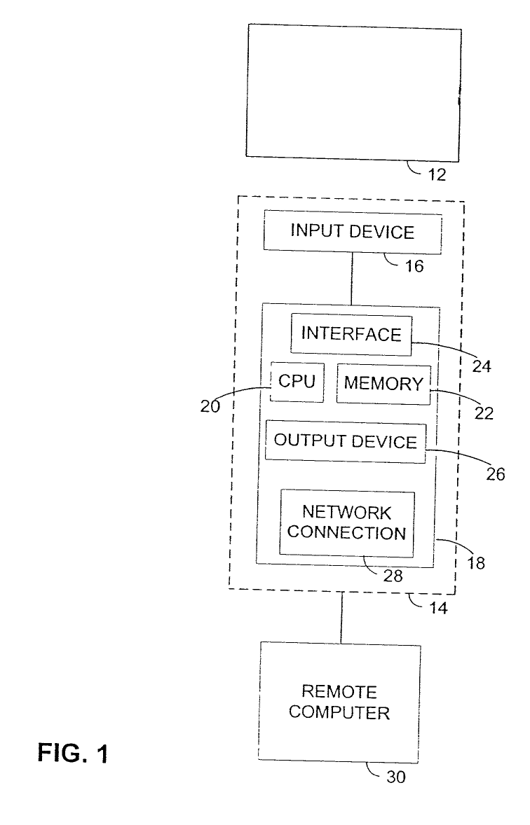

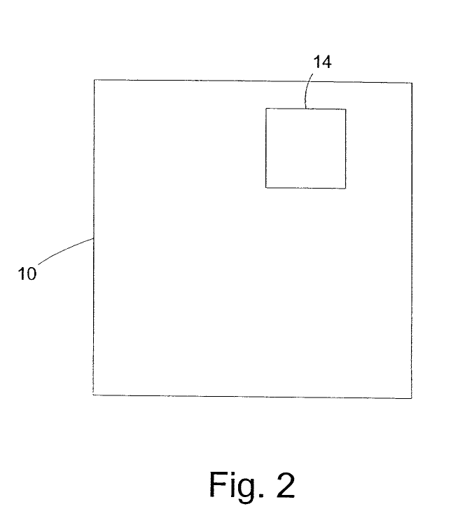

With reference to FIG. 1, an encoded article 12 is presented to a reader station 14 for reading and decoding. The reading station 14 may be incorporated with (or otherwise in communication with) an appliance 10, as shown in FIG. 2. The reader station 14 includes an input device 16 and a processor 18.

The input device 16 can take various forms, including a flatbed scanner, a hand scanner (including an imaging mouse), web cam, a video camera, a still digital camera, etc. The processor 18 can be a general purpose or dedicated computer, including a CPU 20, memory 22, an interface 24 to the input device 16. Alternatively, the processor 18 could include dedicated electrical processing circuitry. The reader 14 may optionally include a display screen (or other output device) 26 and a network connection 28. The network connection can be used to connect, through a network, intranet, the internet, or otherwise, to a remote computer 30/ Preferably, computer 30 includes a memory and a database (or other data structure). In an alternative embodiment, a database is locally maintained with the reader or the appliance. In this case, the reader preferably includes bus and/or communication structure to facilitate communications with the database and appliance.

Suitable software programming instructions, stored in memory 22 of processor 18, or in the memory of remote computer 30, can be used to affect various types of functionality for the reader and/or appliance. The software instructions may even be integrated with an operating system (e.g., Windows), application (e.g., a browser) or other software module.

One functionality is to enable an appliance to operate or perform a function. In this regard, the encoded information (e.g., watermark payload or identifier, encoded data or linked information) preferably serves as a monetary unit or access token. For example, the encoded information may serve as payment at a cash register. In another example, a subway system accepts the encoded data as payment. In still another example, a watermark with encoded information replaces a token or quarter to operate a jukebox, video game, child's ride, etc. These are just a few examples to illustrate the ability of encoded information to function as monetary units or access tokens.

When the reader 14 senses the digital object identifier on article 12, the identifier may be dispatched to the database, which is maintained either locally or remotely. The database accesses a data record corresponding to that identifier. Stored in the data record is information specifying the response that should be provided. For example, the response may be to authorize a purchase based on available funds or credit, deny the purchase (e.g., indicate that the credit has been used or expired), or to provide credit or permission to enable an appliance (e.g., to turn on, operate, allow access to, play, activate, etc.). The accessed data record can be updated to reflect activity, purchases, the number of times accessed by individual appliances or vendors, etc.

In another embodiment, the reader 14 senses the digital object identifier. The reader decodes the identifier and/or extracts any additionally encoded data (e.g., a payload). In this embodiment, the identifier and/or payload provide the authorization, without the need to query a database. For example, the identifier and/or payload may contain a predetermined bit sequence, which when found by the decoder enables the appliance or approves a purchase. The reader (or appliance) could also keep a list of authorized identifiers. Such a list is consulted to determine whether a decoded identifier (or payload) matches an authorized identifier or bit sequence. The decoded identifier can be recorded to facilitate future payment, statistic gathering, etc. The predetermined sequence can be updated in the reader (or appliance) to respond differently to a plurality of identifiers, provide security, limit a time-window for an identifier, etc.

The encoded objects may be sponsored by advertisers or merchants, or may be obtained through payment.

An encoded object may also be refreshed once its predetermined credit or access limit is exhausted. For example, a subway system may issues digitally embedded objects, such as cards, to enable passage through the system. The embedded cards include an identifier, which is recorded each time a rider uses the system. A system database can be employed to manage an identifier in relation to a number of rides taken by the card's bearer. When a predetermined number is exhausted, a rider can refresh the card by further payment. The rider presents the card to a reader, which is connected to a central database. The rider selects a refresh option (e.g., to add more money to the account) via the reader and adds additional payment (e.g., via a credit card, coin or bills). The database is updated accordingly. (Alternatively, the card is automatically refreshed via a direct withdrawal, credit card payment, etc.). This system provides additional security and convenience for the rider. If a card is lost, the rider can simply report the associated identifier to the database and request a refund or credit.

Further implementations are discussed below.

Jukebox

The term “jukebox” is used broadly herein and includes an apparatus for playing music, videos, and/or advertisements, etc. Accordingly, a jukebox maybe a general purpose or dedicated computer having access to a repository of digital music and/or videos (e.g., MP3 files, ripped or transferred digital files, etc.). The computer may be controlled with an operating system or dedicated software. The repository may be stored in an associated storage device (e.g., electronic memory circuits, hard drive, CDs, tape drive, removable media, on-line storage device, etc.). The jukebox has, or is in communication with, an output device for performance of the files. The output device may include speakers, a display screen, and/or a projector, etc. The jukebox may have an optional network connection through which it communicates with an external computer. Through the external computer, the jukebox may update its repository, receive streaming media for immediate or time-delayed play, provide for payment of royalties, report activity, etc. Such payment, reporting and updating activities may be alternatively carried out through local management and file keeping.

The jukebox alternatively includes a library comprising records, CDs, DVDs digital files, or a combination of such. Such a jukebox may also have a processor and associated software stored therein to facilitate system activity, or may have dedicated electronics and/or mechanical components to perform similar functionality. Of course, the jukebox could have a combination of software and dedicated components.

A jukebox typically includes a user interface through which available music is selected. The interface may include push buttons, a touch screen, and/or keyboard entry, etc. A jukebox also typically includes an input through which money (or tokens) is received to enable the apparatus (hereinafter a “money receiver”). Upon entry of money, the jukebox is enabled and a user is then able to select a song or video. Of course, other such known jukebox features may also be included in the jukebox discussed herein.

Preferably, the present invention incorporates a digital watermark reader as discussed above to replace a jukebox's money receiver. Accordingly, instead of being activated through a bill, token or coin, the jukebox is activated upon detection and/or processing of a watermark. The reader determines a credit or value from the watermark (or linked data) and enables the jukebox to perform a corresponding number of selections (e.g., songs, videos, etc.). The reader may enable the jukebox through an electrical and/or mechanical signal. Consider the following example.

A coffee shop installs a watermark-enabled jukebox. The coffee shop distributes coffee in cups (or sleeved/jacketed cups) encoded with digital watermarks. The objects marked needn't be coffee cups/jackets. Any object can be employed. Even napkins, clothing, menus, advertisements can be utilized. Of course, objects needn't be marked with just one identifier. Multiple identifiers may be used. Two or more watermarks may even occupy the same region of an object.

The jukebox reader may be arranged to encourage a consumer to place the cup at a location that is optimized for reading with the reader. The jukebox reader reads the watermark, and enables the jukebox based on the decoded watermark data. For example, if the reader detects a predetermined watermark identifier it activates the jukebox. Alternatively, the reader may extract payload data to determine credit information. In these cases, the identifier and/or payload information may be recorded and tracked to regulate usage, identify music selections, and/or track advertisements payments, etc.

As even a further alternative, the reader may extract the identifier (and/or payload) and access a database (remote or local). The database accesses a data record corresponding to that identifier. Stored in the data record is information specifying the response that should be provided. The response may include supplying (to the jukebox or a computer in communication with the jukebox) additional data regarding the amount of credit (e.g., credit for 1 or 2 songs, etc.) and billing/record keeping information. One feature of this arrangement is that changing the information stored in the database record, rather than changing the identifier with which the cup is encoded can tailor the response. For example, credit data can be updated to permit or restrict future jukebox credit.

Similarly, when the customer leaves the coffee shop and takes the cup down the street, other coffee shops (or stores) may have similar jukeboxes (or other watermark-enabled appliances). Presenting the cup to other merchants' appliances can yield a similar or different response. That is, the response triggered by a cup can be context-dependent, as discussed in assignee's copending U.S. application Ser. No. 09/697,009. The same object identifier is sensed by all terminals, but the databases consulted may be different, or information about the location/context of the terminal is relayed to a shared database, permitting the terminals—and corresponding responses—to be differentiated. As an alternative arrangement, a watermarked object (e.g., cup) could be presented to a compliant reader to trigger an associated printer to produce a coupon, winning ticket, or other advertisement. The coupon (or winning ticket, or other advertisement) can include a watermark, which is generated on the fly to represent a particular offering. The resulting watermarked coupon can then be presented at a jukebox reader, at home, or at another location, to activate an appliance, etc.

The incentive model for the watermark-enabled jukebox (as well as other appliances) can be structured in many ways. A merchant absorbs the associated cost in a first model. The first model may include encoding all the cups with the same identifier. Or different identifiers can be assigned to cups of varying sizes (or amounts). To illustrate, a consumer may receive credit for 1 selection on the jukebox with the purchase of a small cup of coffee, which is embedded with a first watermark identifier. The consumer may alternatively receive credit for 2 selections with the purchase of a large cup of coffee, which is embedded with a second watermark identifier. As a further alternative, unique identifiers may be respectively encoded for each cup. The unique identifiers can then be used to limit credit, track usage, etc. The merchant advertises that the cups enable the jukebox. The cups can be given away for free, or provided with the purchase of coffee, food, goods, etc. The encoded cups are then used to activate the jukebox. Preferably, the jukebox maintains a record of songs played via the identifiers. The record helps to facilitate payment by the merchant to the jukebox owner for song royalties, lease, etc.

In a second model, an advertiser covers the cost of encoding the objects (e.g., cups) and/or payment of royalties, jukebox plays, etc. In this model, an advertisement may be presented to the purchaser upon selection of a jukebox option. (For example, prior to playing a song, the jukebox may play an advertisement, which says something like “This song brought to you by Lou's Plumbing.” Or if the jukebox has a display screen, a video or still image advertisement may be displayed.). The advertiser may also advertise on the coffee cup or jacket.

Preferably, the jukebox maintains a record of songs played via encoded objects. The record helps to facilitate payment by the advertiser (or different advertisers) to the jukebox owner for song royalties, lease, etc.

Of course, alternative incentive models are possible with a watermark-enabled jukebox or other appliance.

Virtual Reality and Video Games

Arcade-like video and interactive virtual reality games can also be equipped with a watermark reader. Encoded objects are then used to enable play as discussed above. The objects (e.g., an access card, ID, cups, etc.) can be purchased or sponsored. The objects can also be refreshed as discussed above.

Encoded objects can facilitate parental control functionality. For example, the encoded identifier (or payload or accessed data) may include a parental bit (or bits), which restricts access to certain types of video games (e.g., games including violent or sexually explicit material). A gamer may be able to obtain an encoded object based upon suitable age restrictions or parental permission. Preferably, the watermark reader will not enable a game if the parental bit does not match the required level for that particular game.

Carnival and Children Rides

The present invention may also be used in connection with carnival-like and children rides (e.g., stationary cars, carousels, etc.). For example, a watermark reader may be installed in such rides to enable the ride in the same manner discussed above. The encoded objects may include additional data, which further limits access (e.g., based on height, age, content, etc.).

Concluding Remarks

To provide a comprehensive disclosure without unduly lengthening this specification, applicants incorporate by reference the above-cited patent documents.

Having described and illustrated the principles of the invention with reference to illustrative embodiments, it should be recognized that the invention is not so limited. The present invention finds application beyond such illustrative embodiments. For example, any coin-operated appliance may be equipped with an encoded object reader to facilitate operation. Also, encoded objects may be used as monetary value for credit in stores, restaurants, transportation systems and/or vehicles, brokerage houses, online vendors, casinos, dispensing machines, vending machines, clubs, street vendors, stadiums, theaters, laundry-mats, etc.

While the detailed embodiments employ digital watermarking, other machine-readable data representations can be used instead (e.g., bar codes, glyphs, RF IDs, mag stripes, smart card technology, etc.).

It will be appreciated that the section headings in this document are merely provided as a convenience and invoke no substantive limitations. For example, the “Jukebox” section incorporates features and advantages discussed in other sections of the document. The other sections likewise draw from other areas of the document.

As a further alternative, the jukebox watermark reader discussed above could compliment, instead of replace, a money receiver. This alternative allows for activation of the jukebox both by a coin (or bill) and a watermark.

The implementation of the functionality described above (including watermark decoding) is straightforward to artisans in the field, and thus not further belabored here. Conventionally, such technology is implemented by suitable software, stored in long term memory (e.g., disk, ROM, etc.), and transferred to temporary memory (e.g., RAM) for execution on an associated CPU. In other implementations, the functionality can be achieved by dedicated hardware, or by a combination of hardware and software. Reprogrammable logic, including FPGAs, can advantageously be employed in certain implementations.

It should be recognized that the particular combinations of elements and features in the above-detailed embodiments are exemplary only; the interchanging and substitution of these teachings with other teachings in this and the incorporated-by-reference patents/applications are also contemplated.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

We claim:

1. A coffee cup, or jacket for a coffee cup, having plural bit data encoded thereon in the form of a digital watermark, the data to enable an appliance.

2. A jukebox comprising:
a repository comprising audio or video files;
a user interface through which an audio or video file is selected;
an output device; and
a watermark reader to enable the jukebox to perform the selected audio or video file via the output device, said watermark reader enabling the jukebox based on a digital watermark comprising plural-bit data.

3. The jukebox according to claim 2, wherein the plural-bit data comprises a monetary equivalent.

4. The jukebox according to claim 2, wherein in the plural-bit data comprises an access token.

5. The jukebox according to claim 2, wherein in the plural-bit data comprises a permission.

6. The jukebox according to claim 2, further comprising an interface through which the plural-bit data is relayed to a computer, the computer maintaining a database comprising credit information, the plural-bit data being used to index credit information.

7. The jukebox according to claim 6, wherein the credit information is received through said interface to enable the jukebox.

8. A method of activating an appliance, the appliance comprising a watermark detector, said method comprising the steps of:
presenting a digitally watermarked object to the detector;
in the detector, detecting and decoding the watermark; and
activating the appliance in accordance with the watermark.

9. The method according to claim 8, wherein said activating step comprises the steps of:
extracting data from the watermark;
indexing into a database via the data to identify additional information; and
activating the appliance according to the additional information.

10. The method according to claim 9, wherein the additional information comprises a monetary equivalent.

11. The method according to claim 9, wherein the additional information comprises an access token.

12. The method according to claim 9, wherein the appliance is activated only to the extent provided for by the monetary equivalent.

13. A physical object for use as a monetary equivalent, said physical object comprising:
plural bit data encoded in the form of a digital watermark, wherein said plural bit data is used to link to additional data, the additional data comprising monetary information.

14. The physical object according to claim 13, wherein said watermark comprises the additional data in the form of a payload.

15. The physical object according to claim 13, wherein said additional data resides in a computer.

16. A method of doing business comprising the steps of:
reading a digitally watermarked object, the watermark comprising at least an identifier;
accessing additional information via the identifier, the additional information comprising monetary data; and
using the monetary data to facilitate a transaction.

17. The method according to claim 16, wherein the transaction is a purchase of a good, financial instrument or service.

18. The method according to claim 16, wherein the transaction is an activation of an appliance.

19. The method according to claim 18, wherein monetary data includes information regarding a sponsor or advertiser.

20. A method of doing business comprising the steps of:
reading a digitally watermarked object, the watermark comprising at least plural-bit data, the plural bit data comprising at least monetary data; and
using the monetary data to facilitate a transaction.

21. A method of activating an appliance, the appliance comprising a watermark reader, said method comprising the steps of:
in the reader, reading a digitally encoded object to extract plural-bit data from a digital watermark; and
activating the appliance in accordance with the extracted plural-bit data.

22. The method according to claim 21, further comprising the step of indexing into a database with the plural-bit data to identify additional information, the additional information comprising a credit amount, and wherein said activating step comprises activating the appliance in accordance with the credit amount.

23. The method according to claim 22, farther comprising the step of refreshing the credit amount.

24. The method according to claim 23, wherein the appliance comprises a transportation pass system.

25. The method according to claim 21, wherein said plural-bit data comprises a credit amount, and said appliance is activated in accordance with the credit amount.

26. The method according to claim 25, wherein the appliance comprises a jukebox.

27. The method according to claim 27, wherein the plural bit data comprises access restriction data and said method further comprises the step of regulating activation of the appliance with the access restriction data.

28. A jukebox comprising:
a repository comprising records or compact discs;
a user interface through which a record or compact disc is selected;
an output device; and
a watermark reader to enable the jukebox to perform the selected record or compact disc via the output device, said watermark reader enabling the jukebox based on a digital watermark comprising plural-bit data.

29. A method of activating an appliance, the appliance comprising a watermark reader, said method comprising the steps of:
in the reader, reading a digitally encoded object to extract plural-bit data from a digital watermark;
comparing the plural-bit data to predetermined data; and
activating the appliance only when the plural-bit data corresponds with the predetermined data.
